(19) United States
(12) Patent Application Publication
(10) Pub. No.: US 2026/0101292 A1
(43) Pub. Date: Apr. 9, 2026

(54) PROVIDING INFORMATION ABOUT MULTI-MODAL SERVICES TO A RAN

(71) Applicant: InterDigital Patent Holdings, Inc., Wilmington, DE (US)

(72) Inventors: Magurawalage Chathura Madhusanka Sarathchandra, London (GB); Michael Starsinic, Newtown, PA (US); Samir Ferdi, Kirkland (CA); Jaya Rao, Montreal (CA); Samuli Turtinen, Ii (FI); Faris Alfarhan, Montreal (CA); Srinivas Gudumasu, Montreal (CA); Francois Periard, Montreal (CA); Kevin Di Lallo, Laval (CA); Achref Methenni, Montreal (CA)

(73) Assignee: InterDigital Patent Holdings, Inc., Wilmington, DE (US)

(21) Appl. No.: 18/905,943

(22) Filed: Oct. 3, 2024

(51) Int. Cl. H04W 56/00

(52) U.S. Cl. CPC H04W 56/001

(57) ABSTRACT

Systems, methods, and instrumentalities are described herein related to providing information about multi-modal services to a radio access network (RAN). In examples, a first network node may receive information associated with an application layer session and a multi-modal service identifier (MMSID) that may be associated with the application layer session. The first network node may generate a policy and charging control (PCC) rule for a wireless transmit/receive unit (WTRU) using the received information. The MMSID may be used to generate an association ID. The PCC rule may be sent to a second network node. The PCC rule may include the association ID.

### BACKGROUND

Mobile communications using wireless communication continue to evolve. A sixth generation may be referred to as 6G. A fifth generation may be referred to as 5G. A previous (e.g., legacy) generation of mobile communication may be, for example, fourth generation (4G) long term evolution (LTE).

### SUMMARY

Systems, methods, and instrumentalities are described herein related to providing information about multi-modal services to a radio access network (RAN).

In examples, a first network node (e.g., a policy control function (PCF)) may receive information associated with an application layer session and a multi-modal service identifier (MMSID) that may be associated with the application layer session. The first network node may generate a policy and charging control (PCC) rule for a wireless transmit/receive unit (WTRU) using the received information. The MMSID may be used to generate an association ID. The PCC rule may be sent to a second network node. The PCC rule may include the association ID.

In examples, the received information may include a synchronization threshold. The synchronization threshold may be a maximum tolerable time delay between two flows. The received information may include descriptions of the two flows. In examples, the application layer session may include a first media type and a second media type. The received information may include a first synchronization threshold associated with the first media type and a second synchronization threshold associated with the second media type. The first synchronization threshold may be associated with a first synchronization group ID and the second synchronization threshold is associated with a second synchronization group ID. The first synchronization group ID and the second synchronization group ID may identify two or more flows. The PCC rule may include at least one of the first synchronization threshold, the second synchronization threshold, the first synchronization group ID, or the second synchronization group ID.

In examples, the association ID may be generated based on both the MMSID and an AF ID. In examples, the first network node may generate the association ID by performing a hash function on input values. The input values may include at least one of the MMSID, an application function (AF) ID, a media type of a flow, or a synchronization group ID. The PCC rule may include at least one of the MMSID, an AF ID, a media type of a flow, or a synchronization group ID. In examples, the first network node may assign a common admission control group ID to the application layer session. The PCC rule may include the common admission control group ID.

In examples, the first network node (e.g., a RAN node) may receive information associated with a quality of service (QoS) profile from a second network node. Data may be prioritized based on the information associated with the QoS profile. In examples, the first network node may receive a protocol data unit (PDU) in a message. The message may indicate a QoS flow indicator (QFI) associated with the PDU. An association identifier (ID) associated with the PDU may be determined based on the information associated with the QoS profile and the QFI associated with the PDU. The first network node may apply a multi-modal aware QoS treatment to the PDU based on the information associated with the QoS profile and the QFI. The PDU may be sent to a wireless transmit/receive unit (WTRU). In examples, the multi-modal aware QoS treatment may include at least one of: configuring a set of one or more logical channels to service one or more QoS flows, providing a level admission control to the one or more QoS flows, determining how to treat PDUs in the same synchronization group, or configuring one or more WTRUs that are associated with the one or more QoS flows with a connected mode discontinuous reception (DRX) timer.

In examples, the information associated with the QoS profile may include an indication of at least a flow associated with the association ID and an indication that the associated ID may be associated with a synchronization group ID and a synchronization threshold. In examples, the first network node may detect that one or more QoS flows are associated with the association ID. Based on detecting that the one or more QoS flows are associated with the association ID, a set of one or more logical channels may be configured to service the one or more QoS flows. Based on detecting that the one or more QoS flows are associated with the association ID, a level admission control may be provided to the one or more QoS flows. In examples, the information associated with the QoS profile may include at least one of an allocation and retention priority (ARP) or admission control group ID. The at least one of the ARP or the admission control group ID may be used to determine whether to accept or reject a QoS flow indicated in the QFI associated with the PDU.

In examples, the PDU may be a first PDU and the message may be a first message. The first network node may receive a second PDU in a second message. The first network node may detect that one or more QoS flows belong to a synchronization group or detect that the first PDU and the second PDU belong to the synchronization group. Based on detecting that the one or more QoS flows belong to the synchronization group or detecting that the first PDU and the second PDU belong to the synchronization group, a priority of the first PDU may be changed if the second PDU has already been delivered. Based on detecting that the one or more QoS flows belong to the synchronization group or detecting that the first PDU and the second PDU belong to the synchronization group, the first PDU and the second PDU may be assigned to logical channels that have a same priority. Based on detecting that the one or more QoS flows belong to the synchronization group or detecting that the first PDU and the second PDU belong to the synchronization group, transmissions of the first PDU and the second PDU may be performed within a connection mode discontinuous reception (CDRX) active duration or within a time window associated with a power saving mode. Based on detecting that the one or more QoS flows belong to the synchronization group or detecting that the first PDU and the second PDU belong to the synchronization group, the first PDU may be discarded if the second PDU is discarded.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example flow diagram for setting up an application function (AF) session with a quality of service (QoS) procedure.

FIG. 3 illustrates an example flow diagram for providing (e.g., configuring) the RAN with information related to multi-modal services, which may enable the RAN to identify flows that belong to the same multi-modal service provided to a user, and the characteristics of the flows (e.g., the media type of each flow).

### DETAILED DESCRIPTION

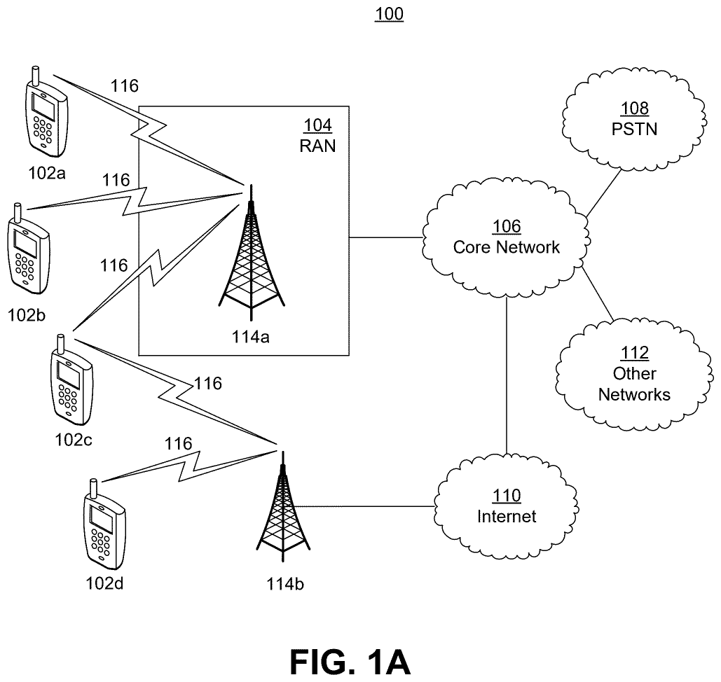

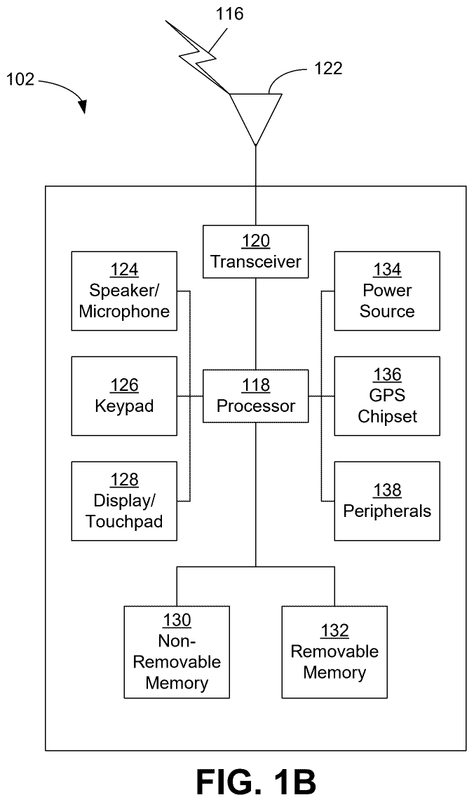

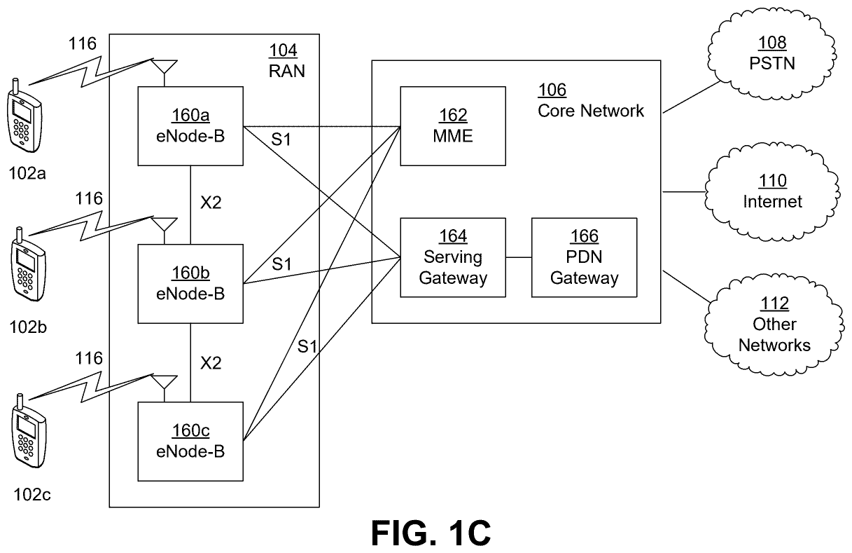

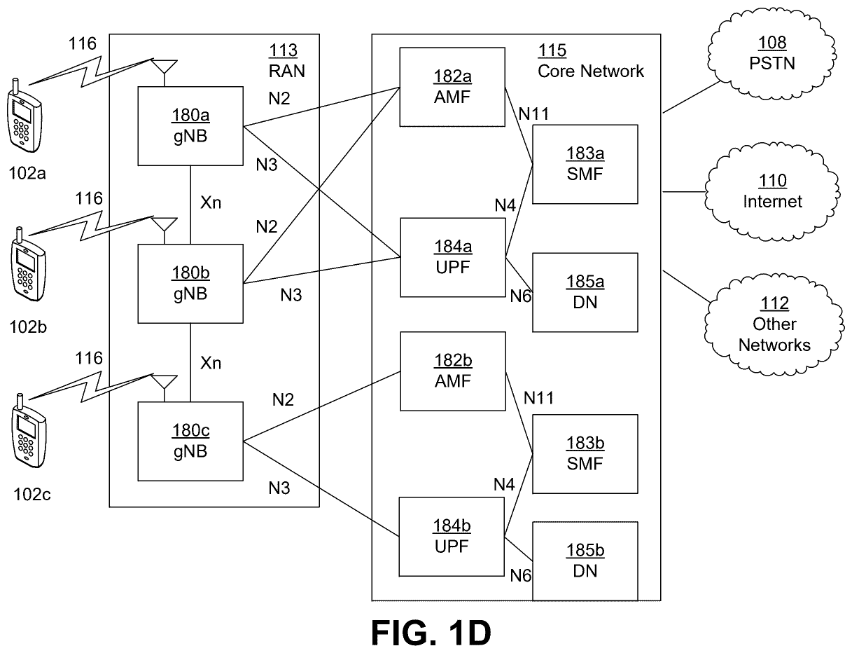

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a node-B, an eNode B, a Home node B, a Home eNode B, a gNB, a NR nodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may anotheranothere anotherr CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems, methods, and instrumentalities are described herein related to providing information about multi-modal services to a radio access network (RAN).

In examples, a first network node (e.g., a policy control function (PCF)) may receive information associated with an application layer session and a multi-modal service identifier (MMSID) that may be associated with the application layer session. The first network node may generate a policy and charging control (PCC) rule for a wireless transmit/receive unit (WTRU) using the received information. The MMSID may be used to generate an association ID. The PCC rule may be sent to a second network node. The PCC rule may include the association ID.

In examples, the received information may include a synchronization threshold. The synchronization threshold may be a maximum tolerable time delay between two flows. The received information may include descriptions of the two flows. In examples, the application layer session may include a first media type and a second media type. The received information may include a first synchronization threshold associated with the first media type and a second synchronization threshold associated with the second media type. The first synchronization threshold may be associated with a first synchronization group ID and the second synchronization threshold is associated with a second synchronization group ID. The first synchronization group ID and the second synchronization group ID may identify two or more flows. The PCC rule may include at least one of the first synchronization threshold, the second synchronization threshold, the first synchronization group ID, or the second synchronization group ID.

In examples, the association ID may be generated based on both the MMSID and an AF ID. In examples, the first network node may generate the association ID by performing a hash function on input values. The input values may include at least one of the MMSID, an application function (AF) ID, a media type of a flow, or a synchronization group ID. The PCC rule may include at least one of the MMSID, an AF ID, a media type of a flow, or a synchronization group ID. In examples, the first network node may assign a common admission control group ID to the application layer session. The PCC rule may include the common admission control group ID.

In examples, the first network node (e.g., a RAN node) may receive information associated with a quality of service (QoS) profile from a second network node. Data may be prioritized based on the information associated with the QoS profile. In examples, the first network node may receive a protocol data unit (PDU) in a message. The message may indicate a QoS flow indicator (QFI) associated with the PDU. An association identifier (ID) associated with the PDU may be determined based on the information associated with the QoS profile and the QFI associated with the PDU. The first network node may apply a multi-modal aware QoS treatment to the PDU based on the information associated with the QoS profile and the QFI. The PDU may be sent to a wireless transmit/receive unit (WTRU). In examples, the multi-modal aware QoS treatment may include at least one of: configuring a set of one or more logical channels to service one or more QoS flows, providing a level admission control to the one or more QoS flows, determining how to treat PDUs in the same synchronization group, or configuring one or more WTRUs that are associated with the one or more QoS flows with a connected mode discontinuous reception (DRX) timer.

In examples, the information associated with the QoS profile may include an indication of at least a flow associated with the association ID and an indication that the associated ID may be associated with a synchronization group ID and a synchronization threshold. In examples, the first network node may detect that one or more QoS flows are associated with the association ID. Based on detecting that the one or more QoS flows are associated with the association ID, a set of one or more logical channels may be configured to service the one or more QoS flows. Based on detecting that the one or more QoS flows are associated with the association ID, a level admission control may be provided to the one or more QoS flows. In examples, the information associated with the QoS profile may include at least one of an allocation and retention priority (ARP) or admission control group ID. The at least one of the ARP or the admission control group ID may be used to determine whether to accept or reject a QoS flow indicated in the QFI associated with the PDU.

In examples, the PDU may be a first PDU and the message may be a first message. The first network node may receive a second PDU in a second message. The first network node may detect that one or more QoS flows belong to a synchronization group or detect that the first PDU and the second PDU belong to the synchronization group. Based on detecting that the one or more QoS flows belong to the synchronization group or detecting that the first PDU and the second PDU belong to the synchronization group, a priority of the first PDU may be changed if the second PDU has already been delivered. Based on detecting that the one or more QoS flows belong to the synchronization group or detecting that the first PDU and the second PDU belong to the synchronization group, the first PDU and the second PDU may be assigned to logical channels that have a same priority. Based on detecting that the one or more QoS flows belong to the synchronization group or detecting that the first PDU and the second PDU belong to the synchronization group, transmissions of the first PDU and the second PDU may be performed within a connection mode discontinuous reception (CDRX) active duration or within a time window associated with a power saving mode. Based on detecting that the one or more QoS flows belong to the synchronization group or detecting that the first PDU and the second PDU belong to the synchronization group, the first PDU may be discarded if the second PDU is discarded.

As described herein, a policy control function (PCF) may construct an association Identifier (association ID). An association ID may be associated with Service Data flows. An association ID may be provided by the PCF to a session management function (SMF) in a policy charging and control (PCC) rule. The SMF may (e.g., then) associate the association ID with a quality of service (QoS) Flow. The SMF may provide the association ID to the RAN in a QoS Profile. The association ID may be constructed by the PCF, for example, such that QoS flows that are part of the same multi-modal session and/or that have similar QoS requirements may be associated with the same association ID. Thus, QoS flows that may be associated with different PDU Sessions and/or different WTRUs may have similar QoS requirements. The RAN may be able to detect that the QoS flows have similar QoS requirements and (e.g., preferably) provide the QoS flows with similar treatment.

An association ID may be associated with a synchronization threshold, for example, so that the RAN may detect if/when QoS flows may (e.g., need to) be synchronized. Detecting that flows need to be synchronized may be based on, for example, information that may be provided to the PCF by an application function (AF) and/or information that may be included in the headers of downlink traffic.

A PCF may (e.g., be able to) provide information to the RAN node that indicates which flows within a multi-modal session are associated. A PCF may (e.g., also be able to) provide information to the RAN node that characterizes how the flows are associated and/or dependent on each other.

The terms application layer session and AF session may be used interchangeably herein.

The terms multi-modal service ID (MMSID), MMSID attribute, and multiModalId may be used interchangeably herein.

The terms AF ID, afAppID attribute, and afAppId may be used interchangeably herein.

The terms RAN node, RAN, eNodeB, gNodeB, and base station may be used interchangeably herein.

In some examples, a PCF may be used to create multi-modal information for the RAN.

A multi-modal service may be a communication service that includes several data flows that may relate to each other and that may be subject to application coordination. The data flows may transfer different types of data (e.g., audio, video, positioning, haptic data) and may come from different sources (e.g., a single WTRU, a single device, or multiple devices connected to the single WTRU, or multiple WTRUs).

A PCF may perform, for example, one or more of the following: receive information about an application layer session that may be associated with a multiModalId attribute; generate one or more PCC rules for a WTRU, e.g., using the multiModalId attribute and the received information; and/or send the PCC rule(s) to a session management function (SMF).

A PCF may receive information about an application layer session that may be associated with a multiModalId attribute. The information and/or multiModalId attribute may be received, for example, through an invocation of the Npcf_PolicyAuthorization service. The information may include for example, one or more of the following: one or more synchronization thresholds for a (e.g., each) media type of the application layer session, which may be associated with multiple media types of the application layer session; an indication of a (e.g., specific) degree of association of the flows, e.g., as different levels of association; one or more synchronization group IDs associated with one or more synchronization thresholds (e.g., a synchronization group ID may be a number that identifies two or more flows); and/or one or more flow descriptions. In some examples, a synchronization threshold may be a number in units of time that indicates maximum tolerable time delay between multiple (e.g., two) flows.

A PCF may generate PCC rules for a WTRU, e.g., using the multiModalId attribute and the received information. A PCC rule may (e.g., be enhanced so that it can) include an association ID. The association ID of a flow may be, for example, one or more (e.g., any combination) of the following: MMSID, the AF ID, and/or the media type of the flow. The association ID may be an identifier that can be used to detect that flows may be one or more of the following: associated with the same association ID; part of the same multi-modal data session; and/or part of the same multi-modal data session and carrying the same type of media. An association ID may be generated, for example, by performing a hash function on input values. For example, association ID=SHA-256 (MMSID, AF_ID, etc.), where the input may be a concatenation of parameters (e.g., as described herein). A synchronization group ID and/or synchronization threshold may be included in the PCC rule, for example, if/when flows are part of the same synchronization group. A PCF may determine that multiple/certain flows within a multi-modal data session may be treated equally (e.g., in terms of admission control) and/or may (e.g., therefore) be assigned a common admission control group ID. A PCC rule may (e.g., be enhanced so that it can) include an admission control group ID.

A PCF may send the PCC rule(s) to an SMF. A (e.g., each) PCC rule may include an association ID. The inputs to the hash calculation may be, for example, the MediaType, multiModalId, afAppId, and/or a synchronization group ID. One or more of the MediaType, multiModalId, afAppId, and/or synchronization group ID may not be input into the hash calculation and/or (e.g., alternatively/instead) may be provided to the SMF, e.g., as part of the PCC rule. The synchronization threshold may (e.g., also) be included in the PCC rule. The admission control group ID may (e.g., also) be included in the PCC rule.

In some examples, a RAN node may use multi-modal information in the RAN.

A RAN node may perform, for example, one or more of the following: receive/store QoS profiles; receive a PDU; and/or apply multi-modal aware QoS treatment.

A RAN node may receive one or more QoS profiles from the SMF (e.g., that were generated by PCF) and/or may store the QoS profile(s) (e.g., for use in prioritizing data based on the QoS Profiles). The QoS Profile(s) may include, for example, an indication that at least two flows are associated with the same association ID. A QoS Profile may indicate that an association ID is associated with a synchronization group ID and/or a synchronization threshold.

A RAN node may receive a PDU. A PDU may be received, for example, in a general packet radio service (GPRS) tunneling protocol in a user plane (GTP-U) message. The header of a GTP-U message may indicate, for example, a QoS flow identifier (QFI) with which the PDU may be associated and/or (e.g., optionally) a synchronization group ID with which the PDU may be associated. The RAN node may determine an association ID that may be associated with the PDU based on, for example, the QFI and/or information in the QoS Profile.

A RAN node may apply multi-modal aware QoS treatment, for example, according to QoS Profiles (e.g., that were received from SMF(s)) and/or information that may have been received in headers of messages (e.g., GTP-U messages) that carry DL PDUs.

An association ID may (e.g., still) be used to detect which flows carry similar type(s) of traffic for the same multi-modal session, for example, if the association ID is calculated based on the same input values (e.g., MediaType, multiModalId, afAppId).

A RAN node may perform one or more actions, for example, if/when the RAN node detects that one or more QoS flows are associated with the same association ID. For example, the RAN node (e.g., based on the detection) may perform one or more (e.g., any) of the following: configure/use the same set of one or more DRBs/logical channels to service the QoS flows (e.g., for providing similar forwarding treatment when transmitting the PDUs of the QoS flows that may be associated with the same association ID); and/or provide/give the flows equal/similar treatment (e.g., in terms of admission control).

A RAN node may perform one or more actions, for example, if/when the RAN node detects that QoS flows and/or PDUs belong to the same synchronization group. For example, the RAN node may (e.g., based on the detection) perform one or more (e.g., any) of the following (e.g., in DL) and/or may configure the WTRU to perform one or more (e.g., any) of the following (e.g., in UL): (e.g., determine to) change the priority of a first PDU, e.g., because a second PDU that may be associated with the same synchronization group may have already been delivered; (e.g., determine to) assign PDUs that may be part of the same synchronization group to logical channels that may have the same priority; (e.g., determine to) perform transmissions of a first PDU and second PDU that may be associated with the same synchronization group within the same connected mode discontinuous reception (CDRX) active duration and/or within a time window (e.g., the same time window) associated with a power saving mode; and/or (e.g., determine to) discard a first PDU when a second PDU that may be associated with the same synchronization group is discarded.

A RAN node may use an allocation and retention priority (ARP) (e.g., that may be indicated in a QoS Profile), for example, to determine whether to accept or reject a QoS Flow (e.g., that may be described by the QoS Profile). A RAN node may (e.g., also) use an admission control group ID (e.g., that may be indicated in the QoS Profile) to determine whether to accept or reject a QoS Flow (e.g., that may be described by the QoS Profile).

Media flows may be associated with one or more multi-modal Service IDs. A media flow may refer to a data flow that may carry a specific type of traffic. The specific type of traffic may be identified by a media type. A media type may include, for example, one or more of the following types: audio, video, data, application, control, text, message, an “other” category, or a “none of the above” category. A network (e.g., 5G System) may allow an AF to configure a PCF with information about media flows and/or to inform the PCF that the media flows are associated with the same multi-modal service. The AF may inform the PCF that media flows are associated with the same multi-modal service, for example, by indicating that each media flow is associated with the same multi-modal Service ID. A PCF may derive PCC rules for the data flows that carry the media flows. The PCF (e.g., if/when the PCF derives the rules) may consider that data flows are associated with the same multi-modal service. For example, the PCF may ensure that (e.g., all) data flows that may carry the same type of media and/or that may be part of the same multi-modal service have the same PCC rules. A data flow may refer to an application layer data flow. An application layer data flow may be described by at least one of: a destination IP address, a destination port number, a source IP address, a source port number, or a protocol type. A data flow may be a flow of an application layer session.

Media flows may be associated with the same or different WTRUs. Deriving the same PCC rules for media flows of a multi-modal session may be advantageous in one or more examples or scenarios. For example, in a gaming scenario, providing a first user with a higher-level QoS than a second user may provide the first user with an unfair advantage in the game.

One or more policy enhancements may be implemented for multi-modal services. For example (e.g., for a single WTRU case), multiple (e.g., all) multi-modal data flows may be transmitted in a single PDU session. The Nnef_AfsessionWithQoS service may allow the AF to provide one or more of the following: a multi-modal Service ID (MMSID), the service parameters (e.g., requirements), and/or the QoS monitoring parameters (e.g., requirements). The PCF may generate the authorized QoS Monitoring policy for each data flow.

Data flows may be associated with more than one WTRU. In some examples, multiple (e.g., all) WTRUs associated with data flow(s) may select the same data network name (DNN)/single network slice selection assistance information (S-NSSAI) combination for the multi-modal service. The AF may use the same Multi-modal Service ID in the interactions with the PCF(s) for (e.g., all) the involved WTRUs that relate to a multi-modal service. The flows may be transmitted over (e.g., separate) PDU Sessions to/from the involved WTRUs. Policy decisions may be taken (e.g., separately/independently) by each PCF, for example, on a per PDU Session basis.

A PCF may (e.g., unambiguously) identify different AF requests that may belong to the same multi-modal service based on, for example, the combination of AF identifier and multi-modal Service ID.

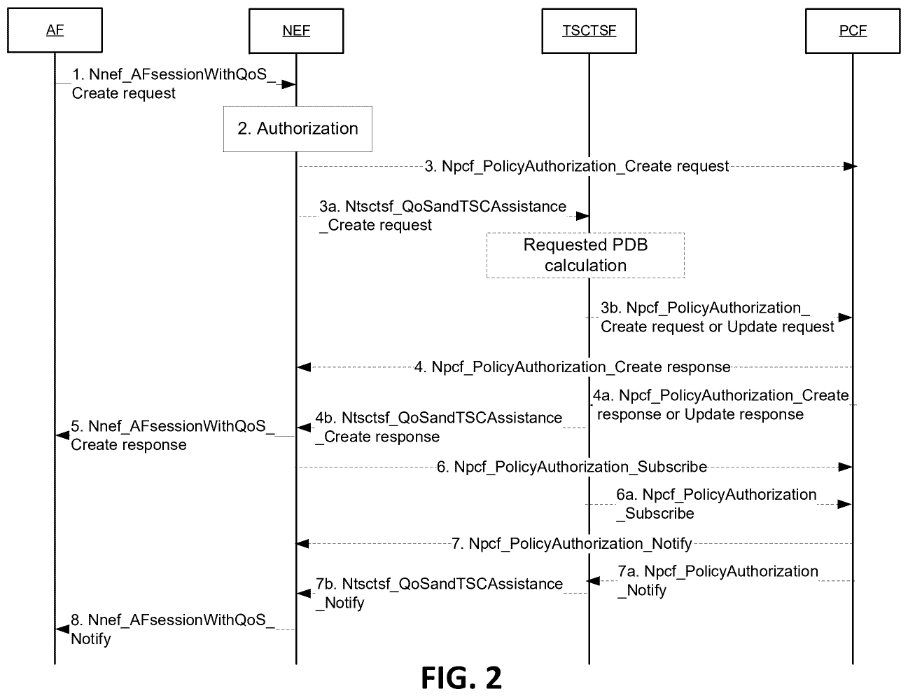

FIG. 2 illustrates an example of setting up an AF session with a QoS procedure. FIG. 2 depicts example procedures for setting up an AF session with a QoS procedure. In FIG. 2, at 1, the AF may provide a multi-modal Service ID, e.g., together with multi-modal Service Requirements information, for a (e.g., each) data flow. Service requirement information may include, for example, media flow attributes (e.g., existing media flow attributes), which may be repeated for each data flow of the multi-modal service.

The multi-modal service ID may be used, for example, if/when an AF provides the service requirements or parameters of a data flow (e.g., each data flow) to the PCF (e.g., via a network exposure function (NEF)) that belong to the multi-modal service. The PCF may reject the AF request, for example, if/when the PCF receives an (e.g., a further) AF request with the same Multi-modal Service ID and PCF authorization fails. An application may decide how to deal with data flows with an authorized AF request with the same multi-modal Service ID (e.g., stop them, adjust the AF request). Multiple AF requests may be used, for example, if/when the multi-modal service comprises data flows of multiple PDU Sessions belonging to the same WTRU or different WTRUs. The PCF may reject the request received from the AF, for example, if the service requirements of a (e.g., any) data flow are not acceptable, e.g., the AF request may be accepted (e.g., only) if the PCF authorization for multiple (e.g., all) data flows is successful. In an example, a partial acceptance of the AF request may not be supported, if the PCT does not know whether the multi-modal service may work with only a sub-set of the data flows. The AF may update the multi-modal Service Requirements information, for example, to modify the attributes applicable to existing data flows and/or to add/remove data flows. The AF may provide (e.g., only) new or changed attributes in the request and/or indicate that an existing data flow is removed (e.g., unchanged attributes may not be expected to be provided again).

A network function (NF) service consumer (e.g., if/when a Multimedia feature is supported) may include a multi-modal Service Identifier, for example, within an attribute (e.g., an “multiModalId” attribute), e.g., to indicate that an AF session (e.g., a new AF session) may relate to a multi-modal service. An NF service consumer (e.g., if/when the multi-modal service combines several media) may provide the service information of (e.g., each) media within an attribute (e.g., the “medComponents” attribute).

Multi-modal Awareness may be implemented in RAN. Multi-modality awareness at RAN may be supported for UL and/or DL. Information (e.g., MMSID and/or synchronization thresholds) may be provided, for example, to allow coordinated handling of flows at RAN. Multi-modal information for UL and/or DL may be provided to RAN.

Policy control (e.g., enhancements) may support multi-modal services, for example, with the use of multi-modal Service ID (MMSID) in AF and PCF. MMSID may be forwarded to RAN, for example, via the control plane, which may impact one or more NG-RAN protocols. NG-RAN behavior may provide for coordinated handling of flows at NG-RAN.

In a network (e.g., a 5G System), the RAN may make decisions that may impact a user's quality of experience. The RAN may not be aware of which QoS flows are part of the same multi-modal service. Examples of decisions that the RAN may make that impact a user's quality of experience may include decisions about one or more of the following: packet prioritization, which packets should be dropped, etc. The RAN may make decisions that result in a first QoS Flow of a multi-modal service receiving better packet level treatment than a second QoS Flow of the same multi-modal service. A RAN decision may result in a poor quality of experience, for example, if the first and second QoS flows carry the same type of media and are associated with different users. For example, providing a first user with better service than a second user of the same multi-modal service may result in a poor, or unfair, service (e.g., gaming) experience.

A multi-modal service ID (MMSID) may be forwarded from the PCF to the RAN. The MMSID alone may not be used by RAN to determine that QoS flows are part of the same multi-modal service. The MMSID may be assigned by the AF. The MMSID may be provided to the PCF. A network (e.g., 5G System) may not prohibit different Afs from assigning the same MMSID to different multi-modal services. A RAN may be provided sufficient information to know which QoS flows are part of the same multi-modal service, but the RAN may still not know which QoS flows carry the same type of media. The RAN may know (e.g., only) which QoS flows may be assigned the same QoS treatment. As described herein, the PCF may construct information that can be used by the RAN to detect which QoS flows carry the same type of media (e.g., construct the information to protect the privacy of the user(s) that may be associated with the media) and send the information to the RAN.

The RAN may be provided with information related to multi-modal services that may be used when taking decisions that impact a user's QoS.

The PCF may construct an association identifier (association ID). The association ID may be associated with Service Data flows. The association ID may be provided by the PCF to the SMF, for example, in a PCC rule. The SMF may (e.g., then) associate the association ID with a QoS Flow. The SMF may provide the association ID to the RAN, for example, in a QoS Profile. The association ID may be constructed by the PCF, for example, so that QoS flows that may be part of the same multi-modal session and have similar QoS requirements may be associated with the same association ID. Although the QoS flows may be associated with different PDU Sessions and different WTRUs, the RAN may (e.g., be able to) detect that the QoS flows have similar QoS requirements or parameters and may (e.g., preferably) provide the QoS flows with similar treatment.

An association ID may be associated with a synchronization threshold, for example, so that the RAN may detect if/when the QoS flows need to be synchronized. Detecting that flows need to be synchronized may be based on, for example, information provided to the PCF by an AF and/or information included in the headers of downlink traffic.

The PCF may (e.g., be able to) provide information to the RAN node that indicates which flows within a multi-modal session may be associated and/or (e.g., also) provide information to the RAN node that characterizes how the flows may be associated or dependent on each other.

The RAN may be provisioned with information of multi-modal services.

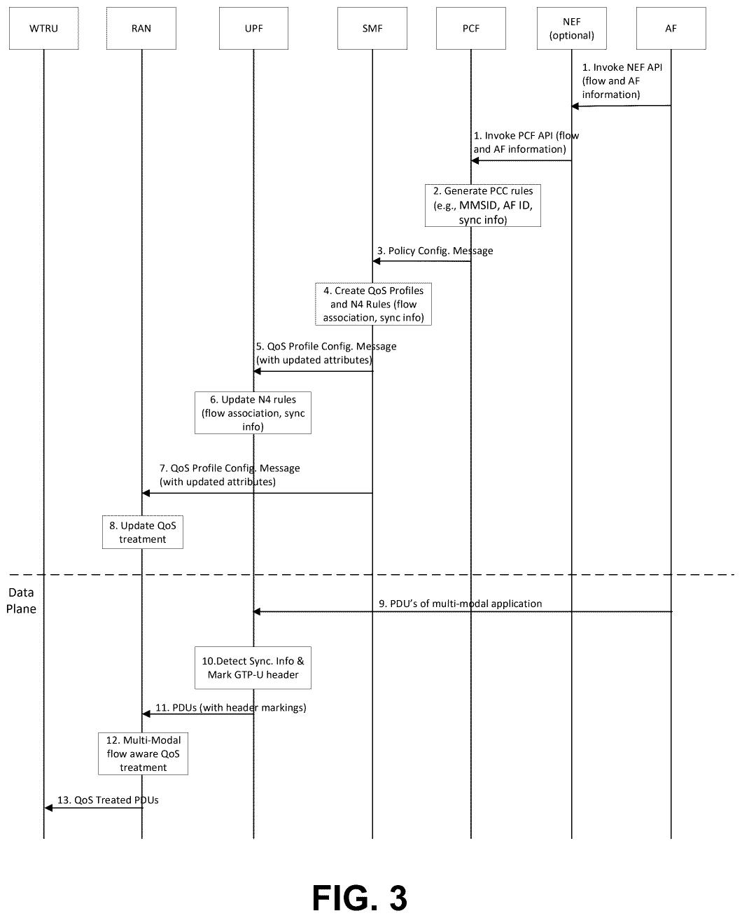

FIG. 3 illustrates an example of a procedure for providing (e.g., configuring) the RAN with information related to multi-modal services, which may enable the RAN to identify flows that belong to the same multi-modal service provided to a user and the characteristics of the flows (e.g., the media type of each flow).

As shown in FIG. 3, at 1, a service consumer may invoke an Npcf_PolicyAuthorization service operation of the PCF. The service consumer may be, for example, an AF or a network exposure function (NEF). The NEF (e.g., if/when the NEF is a service consumer) may be triggered by an AF to invoke the Npcf_PolicyAuthorization service operation. The AF may trigger the NEF to invoke the Npcf_PolicyAuthorization service operation, for example, by invoking an Nnef_AFSessionWithQoS Service operation.

The service consumer may use the Npcf_PolicyAuthorization service to provide the PCF with information about an application layer session to the PCF. The information provided by the service consumer may include, for example, one or more of the following: a multiModalId attribute; an afAppId attribute; a WTRU identifier (e.g., a subscription permanent identifier (SUPI) or a generic public subscription identifier (GPSI)); and/or a medComponents attribute.

The medComponents attribute may include one or more MediaComponent attributes. A (e.g., each) MediaComponent attribute may describe one or more data flows, indicate QoS requirements from the data flow, and/or indicate a media type (e.g., MediaType) that may be associated with the flows. A media type may include, for example, one or more of the following types: audio, video, data, application, control, text, message, an “other” category, and/or a “none of the above” category.

The multiModalId attribute may be used by the service consumer to indicate that the application layer session is associated with a multi-modal service.

The afAppId attribute may identify the AF that invoked the Npcf_PolicyAuthorization service operation or the AF that triggered the NEF to invoke the Npcf_PolicyAuthorization service operation.

The Npcf_PolicyAuthorization service operation may (e.g., be enhanced so that) allow a service consumer to provide additional information about an application layer session to the PCF, for example, if/when an application layer session is associated with a multiModalId attribute.

For example, the service consumer may provide a synchronization threshold for a (e.g., each) media type of the application layer session. The synchronization threshold may indicate to what degree flows of the same media type may (e.g., need to) be synchronized with each other.

For example, the service consumer may provide a synchronization threshold that may be associated with multiple media types of the application layer session. The synchronization threshold may indicate to what degree flows that are associated with the media types may (e.g., need to) be synchronized with each other.

For example, the synchronization threshold provided by the service consumer may indicate a (e.g., specific) degree of association of the flows, e.g., as different levels of association. For example, for flow1 and flow2 that may be part of an application layer session, there may be N synchronization levels: level 1 (no sync needed or best effort sync), level 2 (sync threshold range is between 20 ms to 40 ms), level 3 (sync threshold is between 10 ms to 20 ms).

For example, the service consumer may provide one or more synchronization threshold(s) for the application layer session. A (e.g., each) synchronization threshold may be associated with a synchronization group id. The MediaComponent attribute may (e.g., be enhanced to) allow the service consumer to indicate that the flows that may be associated with a media component (e.g., MediaComponent) attribute may (e.g., also) be associated with a synchronization group ID. The synchronization threshold may indicate to what degree flows that may be associated with the same synchronization Group ID may (e.g., need to) be synchronized with each other.

A synchronization group ID may be a number that identifies two or more flows.

A synchronization threshold may be a number in units of time that indicates a maximum tolerable time delay between (e.g., two) flows. For example, the maximum tolerable time delay between the reception of a (e.g., any) PDU of flow1 in a time window and a PDU in flow2 in the same time window may be less than or equal to a sync threshold value. The maximum tolerable time delay between the reception of a PDU (index/id x) of flow1 and a PDU (index/id y) of flow2 may be less than or equal to a sync threshold value. The maximum tolerable time delay between the reception of a first PDU of a PDU set (index/id X) of flow1 and the last PDU of a PDU set (index/id Y) of flow 2 may be less than or equal to a sync threshold value.

The service consumer may (e.g., alternatively) provide the additional information about the multi-modal data session to the PCF in a service operation that may be separate from the Npcf_PolicyAuthorization service operation that may be used to provide the medComponents attributes to the PCF. Providing the information about the multi-modal data session to the PCF in a service operation that is separate from the Npcf_PolicyAuthorization service operation may be desirable, for example, since the information about the multi-modal data session may apply to multiple medComponents attributes of different application layer sessions.

As shown in FIG. 3, the operation at 1 may be performed one or more times. For example, the service consumer may invoke the Npcf_PolicyAuthorization service operation each time a (e.g., each) WTRU sends and/or receives data in a multi-modal session. The service consumer (e.g., in such a scenario) may provide the PCF with the same afAppId and multiModalId attribute values in the service invocation.

As shown in FIG. 3, at 2, the PCF may generate PCC rules for a WTRU. For example, an (e.g., each) invocation of the Npcf_PolicyAuthorization service operation may be associated with an application layer session of a different WTRU. An (e.g., each) invocation of the Npcf_PolicyAuthorization service operation may trigger the PCF to generate a PCC rule for the WTRU that may be associated with the Npcf_PolicyAuthorization service operation.

The PCF may use the information that was provided by the operation(s) at 1 to generate the PCC rules. A (e.g., each) PCC rule may include a service data flow (e.g., Service Data Flow) template that describes the flow to which the PCC rule applies. A (e.g., each) PCC rule may include policy control information. The policy control information may include, for example, one or more of the following: a QoS identifier (e.g., a 5G QoS identifier (5QI)), maximum bitrate information, an allocation/retention priority (ARP), maximum packet loss rate information, QoS monitoring requirements, and/or alternative QoS parameter sets.

The PCF may generate PCC rules for flows of one or more (e.g., multiple) WTRUs. The flows may be part of the same multi-modal data session. The PCF may generate PCC rules that are similar for each flow that carries the same media type. PCC rules may be considered similar, for example, if they have the same 5QI, ARP, maximum bitrate information, and/or maximum packet loss rate information. The PCF may be aware/know that the flows of different WTRUs are associated with the same multi-modal data session, for example, if the flows are associated with the same afAppId/multiModalId combination.

The PCC rule may (e.g., be enhanced so that it) include an association ID. The association ID of a flow may include (e.g., be a combination of at least) the MMSID and/or the AF ID. The association ID of a flow may (e.g., alternatively) include (e.g., be a combination of) the MMSID, the AF ID, and/or the media type of the flow. The association ID may be an identifier that can be used to detect that flows are associated with the same association ID, are part of the same multi-modal data session, are part of the same multi-modal data session, and/or carry the same type of media. The PCF may construct the association ID, for example, so that the association ID (e.g., uniquely) identifies a multi-modal data session in the network (e.g., across WTRUs, PDU sessions). The resulting association ID may be independent of how the MMSID is allocated by various Afs. For example, the PCF may construct the association ID in a way that is independent and/or transparent to Afs and/or how the Afs allocate the MMSID (e.g., including different Afs allocating the same MMSID value). The PCF may construct the association ID in a privacy preserving manner, for example, to avoid exposing information about the application and/or the multimedia session to another network and/or the RAN. The home operator may (e.g., be required to) enforce a privacy protection (e.g., due to local privacy regulations and/or a service level agreement (SLA) with the AF). For example, the multi-modal data session may be served while roaming in a serving a public land mobile network (PLMN) and/or in the context of a RAN sharing deployment if/when the home operator uses shared a RAN infrastructure with other operators.

For example, the PCF may determine the association ID by performing a hash function on input values. The input values may include (e.g., at least) the MMSID and/or the AF ID. The input values may (e.g., also) include media type. The input values may (e.g., also) include, for example, one or more of the following: the PLMN ID that may be associated with the PCF, the identifier of the PCF instance, the PCF Group ID, and/or a PCF Set ID. The result of the hash function may be the association ID.

The hash function used may be, for example, collision resistant, pre-image resistant, and/or deterministic. Collision resistant indicates that it may be unlikely or impossible for different combinations of input values (e.g., MMSID, AF ID) to result in the same calculation result (e.g., association ID). Pre-image resistant indicates that it may be hard to reverse the function, such as to find the input (e.g., AF ID) given the output (e.g., association ID). Deterministic indicates the same input may result in the same output. A deterministic hash function may be useful to ensure that the same association ID is generated by a PCF (e.g., for example, even when a data multimedia session is served by different SMFs/PCFs), for example, given the same input parameters to the hash function may be used across the various PCFs.

An association ID may be a concatenation, e.g., a concatenation of the media type (e.g., MediaType), multiModalId, and/or afAppId. In some examples, a concatenated association ID (e.g., a concatenation of the MediaType, multiModalId, and/or afAppId) may result in one or more being exposed, or shared (e.g., in terms of privacy). For example, sending the association ID to a RAN node may provide the RAN node with information about the application server that the user of the WTRU communicates with and/or the type of traffic (e.g., media) that the user may be sending and/or receiving. The PCF may be a first PLMN (e.g., the home PLMN (HPLMN)), and the RAN node may be in a second PLMN (e.g., the visiting PLMN (VPLMN)). Privacy issues may arise, for example, if the PCF provides the AF ID and/or Media Type values to the VPLMN. In an example, providing an association ID that is the result of a hash operation may prevent the AF ID and/or Media Type from being exposed, or shared, with the VPLMN.

An example of a hash may be, for example, association ID=SHA-256 (MMSID, AF_ID, etc.), where the input may be a concatenation of parameters (e.g., as described herein) and SHA-256 represents an example of a (e.g., standard) cryptographic hash function.

The output of the hash function may be a string (e.g., instead of a numerical value). The AF ID and/or MMSID may have a numerical value (e.g., integer value). The output of the hash function may be converted to a numerical value, e.g., an integer, which may be assigned to the association ID.

The association ID may be used by the SMF and/or RAN node to detect that flows are part of the same multi-modal data session, for example, if/when the media type is not an input to the hash function, the multiModalId is an input to the hash function, and the afAppId is an input to the hash function.

The association ID may be used by the SMF and/or RAN node to detect that flows are part of the same multi-modal data session and/or that the flows carry the same type of media, for example, if/when the media type is an input to the hash function, the multiModalId is an input to the hash function, and the afAppId is an input to the hash function.

The PCF may include as an input of the hash function (e.g., together with the AF identifier and/or MMSID) a value that conveys the date and/or time when the AF session is provided. A network (e.g., 5G network) function (e.g., the network data analytics function (NWDAF)) may perform data collection related to the multi-modal AF session. For example, the association ID may be collected by a network function. The MMSID and/or AF ID may be part of the dataset (e.g., to be) collected.

The MMSID value may be reused by the application function, for example, in another day (e.g., assuming it takes a day or more for the AF to reuse the same MMSID). Using the AF ID, MMSID may produce the same hash function and the same association ID, e.g., even though it is a different AF session.

A network (e.g., 5G core (5GC) core network) may perform data collection, which the NWDAF may use. In some examples, the AF ID, MMSID, and association ID may have the same values upon reuse (e.g., in both cases), for example, since AF ID may be the same, and MMSID may have been reused a day later. A model (e.g., a machine-learning (ML) model) trained on data including the information may assume that the same session is being referred to, where the training may be inaccurate and/or may result in an inaccurate trained model. Including an indication of time as input to the hash function, e.g., the day of the AF session, may allow the production of a different association ID, which may result in an associated ID (e.g., a unique association ID), for example, even if the MMSID was reused later.

The synchronization group ID and/or synchronization threshold may be included in the PCC rule, for example, if/when flows are part of the same synchronization group. In some examples, the synchronization group ID may not be included in the PCC rule, and the synchronization threshold may be included in the PCC rule. The synchronization group ID may (e.g., alternatively) be an input to the hash function, for example, so that flows (e.g., all flows) that are part of the synchronization group may share a common association ID.

The PCF may be configured with information that can be used to determine that a (e.g., certain) flow within a multi-modal data session should be treated equally, e.g., in terms of admission control. For example, the service consumer may indicate (e.g., in the Npcf_PolicyAuthorization service operation) that a flow is part of an admission control group. For example, the PCF may determine which flows are part of the same admission control group, e.g., based on a policy that may be configured (e.g., locally) in the PCF. For example, the PCF may determine that flows (e.g., all flows) that carry the same media type are part of the same admission control group.

Flows that are part of the same admission control group may be assigned the same ARP and/or (e.g., also) the same admission control group ID. The PCC rule may (e.g., be enhanced so that it can) include an admission control group ID.

The generation of PCC rules (e.g., as shown at 2 in FIG. 3) may be performed for each WTRU that may be associated with flows of the multi-modal data session.

As shown in FIG. 3, at 3, the PCF may send the PCC rules to the SMF. As described with respect to generation of PCC rules at 2, a (e.g., each) PCC rule may include an association ID. The association ID may be the result of a hash calculation. The inputs to the hash calculation may be, for example, the MediaType (e.g., media type), multiModalId, afAppId, and/or a synchronization group ID. In some (e.g., alternative) examples, one or more (e.g., any) of the MediaType, multiModalId, afAppId, and/or synchronization group ID may not be input into (e.g., may be excluded from) the hash calculation. Information that may not be an input to the hash calculation may (e.g., instead) be provided to the SMF, e.g., as part of the PCC rule. The synchronization threshold may (e.g., also) be included in the PCC rule. The admission control group ID may (e.g., also) be included in the PCC rule.

The PCF may send PCC rules to the SMF(s) that serve a (e.g., each) PDU session that may be used to carry traffic for the multi-modal session.

At 4, the SMF may generate QoS profiles, e.g., using the PCC rules received from PCF. A QoS profile may include, for example, a 5QI, an ARP, and/or a QFI. The QoS profile may (e.g., be enhanced so that it may) include the association ID. The MediaType (e.g., media type), multiModalId, afAppId, and/or synchronization group ID may (e.g., also) be part of the QoS Profile, for example, if the association ID is not based on (e.g., any of) the MediaType, multiModalId, afAppId, and/or synchronization group ID. The synchronization threshold may (e.g., also) be included in the QoS Profile. The admission control group ID may (e.g., also) be included in the QoS Profile.

The inclusion of the association ID on the QoS Profile may enable the RAN node to determine which flows are part of the same multi-modal session. The RAN node may (e.g., also be able to) determine which flows carry the same type of media in the multi-modal session, for example, if the MediaType (e.g., media type) is included in the QoS profile and/or used to calculate the association ID. The RAN node may (e.g., also be able to) determine which flows to synchronize, for example, if the synchronization group ID is included in the QoS profile and/or used to calculate the association ID.

The SMF may generate rules (e.g., N4 rules). The N4 rules may include PDRs. The N4 rules may (e.g., be enhanced so that) indicate one or more of the following: that traffic that matches the PDR is associated with a synchronization group ID; and/or that the synchronization group ID of a PDU may be detected from header information of the PDU.

The SMF may generate N4 rules and/or QoS profiles for a (e.g., each) PDU session that may be used to carry traffic for the multi-modal session.

At 5, the SMF may send N4 rules (e.g., that were generated at 4) to the UPF.

The SMF may send N4 rules to the PSA UPF, for example, for a (e.g., each) PDU session that may be used to carry traffic for the multi-modal session.

At 6, the UPF may receive and/or store the N4 rules. The UPF may start packet detection and forwarding, e.g., according to the received N4 rule(s).

At 7, the SMF may send the QoS profile(s) (e.g., that were generated at 4) to the RAN.

At 8, the RAN may receive and/or store the QoS profile(s). The RAN may (e.g., begin to) prioritize data, e.g., based on the QoS profile(s).

At 9, the UPF may receive DL traffic from an application server. The DL traffic may be PDUs.

At 10, the UPF may use the N4 rules to detect what QoS flow a (e.g., each) PDU is associated with and/or (e.g., optionally) what synchronization group ID the PDU is associated with.

The N4 rules (e.g., as described with respect to operations at 4) may (e.g., have been enhanced so that the N4 rules can) be used to determine a synchronization group ID that is associated with the PDU. Determination of the synchronization group ID may (e.g., then) trigger the UPF to include the synchronization group ID in the GTP-U header of the message that is used to send the PDU to the RAN node.

At 11, the RAN may receive a PDU. The PDU may be received in a GTP-U message. The header of the GTP-U message may indicate the QFI that the PDU is associated with and/or (e.g., optionally) the synchronization group ID the PDU is associated with.

The operations at 9, 10, and 11 may be performed for a (e.g., each) PDU that is received by the UPF in a (e.g., each) PDU session that carries traffic for the multi-modal session.

At 12, the RAN may apply multi-modal aware QoS treatment, for example, according to QoS profiles (e.g., that were received from SMF(s)) and/or the information that was received in headers of the GTP-U messages that carry DL PDUs.

The PDU sessions that carry the traffic of the multi-modal session may be served by different SMFs and/or different PCFs. The association ID may still be used to detect which flows carry similar type(s) of traffic for the same multi-modal session, for example, if the association ID is calculated based on the same input values (e.g., MediaType, multiModalId, afAppId). The RAN node may not be able to (e.g., easily) determine which application servers and/or what type of traffic is carried in each QoS flow, for example, if the association ID is the result of a hash operation.

The RAN node may detect that one or more QoS flows, which may be part of different PDU Sessions and/or may be associated with different WTRUs, are associated with the same association ID. The RAN node (e.g., based on the detection that one or more QoS flows are associated with the same association ID) may do, for example, one or more (e.g., any) of the following: configure/use the same set of one or more DRBs/logical channels to service the QoS flows (e.g., for providing similar forwarding treatment when transmitting the PDUs of the QoS flows that are associated with the same association ID); configure/use the same types of one or more DRBs/logical channels to service the QoS flows (e.g., in order to provide similar forwarding treatment when transmitting the PDUs of the QoS flows that are associated with the same association ID); check if the flows are part of the same synchronization group; configure the WTRUs that may be associated with the QoS flows with similar connected mode DRX timer values (e.g., so that the flows are likely to experience a similar amount of jitter); and/or give the flows equal/similar treatment (e.g., in terms of admission control).

The RAN node may detect that QoS flows, or PDUs, belong to the same synchronization group. The RAN node (e.g., based on the detection that QoS flows or PDUs belong to the same synchronization group) may perform, for example, one or more (e.g., any) of the following (e.g., in DL) and/or may configure the WTRU to perform, for example, one or more (e.g., any) of the following (e.g., in UL): (e.g., determine to) change the priority of a first PDU because a second PDU that may be associated with the same synchronization group has already been delivered; (e.g., determine to) assign PDUs that may be part of the same synchronization group to logical channels that have the same priority; (e.g., determine to) perform transmissions of a first PDU and a second PDU that may be associated with the same synchronization group within the same CDRX active duration and/or within the same time window that may be associated with a power saving mode; and/or (e.g., determine to) discard a first PDU when a second PDU that may be associated with the same synchronization group is discarded.

The RAN node may use the ARP (e.g., that may be indicated in the QoS profile) to determine whether to accept or reject the QoS flow (e.g., that may be described by the QoS profile). The RAN node may (e.g., also) use the admission control group ID (e.g., that may be indicated in the QoS profile) to determine whether to accept or reject the QoS Flow (e.g., that may be described by the QoS profile).

For example, a first QoS flow may be associated with a first ARP value and a second QoS flow may be associated the same ARP value. The first QoS flow may not be associated with an admission control group ID. The second QoS flow may be associated with an admission control group ID. The first QoS flow may (e.g., alternatively) be associated with an admission control group ID that may be shared with (e.g., relatively few) QoS flows. The second QoS flow may be associated with an admission control group ID that that may be shared with more (e.g., relatively more) QoS flows. In these example scenarios, the RAN node may (e.g., determine to) reject the first QoS Flow and (e.g., all) QoS flows that share the same Admission Control ID, for example, because the first Admission Control Group ID may be associated with fewer flows than the second Admission Control Group ID.

At 13, the RAN may send PDUs to corresponding WTRUs with multi-modal service aware QoS treatment.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A first network node, comprising:
a processor configured to:
receive information associated with an application layer session and a multi-modal service identifier (MMSID) that is associated with the application layer session;
generate a policy and charging control (PCC) rule for a wireless transmit/receive unit (WTRU) using the received information;
use the MMSID to generate an association ID; and
send the PCC rule to a second network node, wherein the PCC rule includes the association ID.

2. The first network node of claim 1, wherein:
the received information includes a synchronization threshold,
the synchronization threshold is a maximum tolerable time delay between two data flows, and
the received information includes descriptions of the two data flows.

3. The first network node of claim 1, wherein:
the application layer session includes a first media type and a second media type, and
the received information includes a first synchronization threshold associated with the first media type and a second synchronization threshold associated with the second media type.

4. The first network node of claim 3, wherein:
the first synchronization threshold is associated with a first synchronization group ID, and the second synchronization threshold is associated with a second synchronization group ID, and
the first synchronization group ID and the second synchronization group ID identify two or more data flows.

5. The first network node of claim 4, wherein the PCC rule includes at least one of the first synchronization threshold, the second synchronization threshold, the first synchronization group ID, or the second synchronization group ID.

6. The first network node of claim 1, wherein the processor is further configured to:
generate the association ID by performing a hash function on input values, wherein the input values include at least one of the MMSID, an application function (AF) ID, a media type of a data flow, or a synchronization group ID.

7. The first network node of claim 1, wherein the association ID is generated based on both the MMSID and an AF ID.

8. The first network node of claim 1, wherein the processor is further configured to:
assign a common admission control group ID to the application layer session.

9. The first network node of claim 8, wherein the PCC rule includes the common admission control group ID.

10. The first network node of claim 1, wherein the PCC rule includes at least one of the MMSID, an AF ID, a media type of a data flow, or a synchronization group ID.

11. A method associated with a first network node, the method comprising:
receiving information associated with an application layer session and a multi-modal service identifier (MMSID) that is associated with the application layer session;
generating a policy and charging control (PCC) rule for a wireless transmit/receive unit (WTRU) using the received information;
using the MMSID to generate an association ID; and
sending the PCC rule to a second network node, wherein the PCC rule includes the association ID.

12. The method of claim 11, wherein:
the received information includes a synchronization threshold,
the synchronization threshold is a maximum tolerable time delay between two data flows, and
the received information includes descriptions of the two data flows.

13. The method of claim 11, wherein:
the application layer session includes a first media type and a second media type, and
the received information includes a first synchronization threshold associated with the first media type and a second synchronization threshold associated with the second media type.

14. The method of claim 13, wherein:
the first synchronization threshold is associated with a first synchronization group ID, and the second synchronization threshold is associated with a second synchronization group ID, and
the first synchronization group ID and the second synchronization group ID identify two or more data flows.

15. The method of claim 14, wherein the PCC rule includes at least one of the first synchronization threshold, the second synchronization threshold, the first synchronization group ID, or the second synchronization group ID.

16. The method of claim 11, further comprising:
generating the association ID by performing a hash function on input values, wherein the input values include at least one of the MMSID, an application function (AF) ID, a media type of a data flow, or a synchronization group ID.

17. The method of claim 11, wherein the association ID is generated based on both the MMSID and an AF ID.

18. The method of claim 11, further comprising:
assigning a common admission control group ID to the application layer session.

19. The method of claim 18, wherein the PCC rule includes the common admission control group ID.

20. The method of claim 11, wherein the PCC rule includes at least one of the MMSID, an AF ID, a media type of a data flow, or a synchronization group ID.
